(19) United States
(12) Patent Application Publication
(10) Pub. No.: US 2017/0180375 A1
(43) Pub. Date: Jun. 22, 2017

(54) SYSTEM AND METHOD FOR PUSH AUTHORIZATION

(71) Applicant: Nachiket DESHPANDE, Mumbai (IN)

(72) Inventor: Nachiket DESHPANDE, Mumbai (IN)

(21) Appl. No.: 15/301,785

(22) PCT Filed: Apr. 29, 2015
(86) PCT No.: PCT/IN2015/000187

§ 371 Date: Oct. 4, 2016

(30) Foreign Application Priority Data
Apr. 30, 2014 (IN) 1505/MUM/2014

(51) Int. Cl. H04L 29/06; H04W 12/06; H04W 12/08; H04L 29/08

(52) U.S. Cl. CPC H04L 63/10; H04L 67/26; H04L 63/083; H04L 63/0861; H04L 63/0823; H04W 12/06; H04W 12/08

(57) ABSTRACT

Disclosed are a system and a method for push authorization. The system and the method are used for push authorization of an information transaction providing seamless authorization mechanism allowing users to receive authorization requests. The system comprises a push request generator (PRG), a plurality of applications/systems connected to the push request generator (PRG), a push authorization node (PAN) and a plurality of client devices. The system and the method allow users to be in complete control of the authorization process/function/system and at the same time increase efficiency and reliability.

### REFERENCE TO RELATED APPLICATIONS

This application is the U.S. national stage of International Application No. PCT/IN2015/000187, filed Apr. 29, 2015, which claims priority to Indian Application No. 1505/MUM/2014, filed Apr. 30, 2014, the disclosures of which are all incorporated herein by reference in their entireties.

### FIELD OF THE INVENTION

The present invention relates to system and method for push authorization and more particularly, to a push system and a method for authentication by a user and for authorization of an information transaction or information flow.

### BACKGROUND OF THE INVENTION

In conventional systems/processes used for authentication of a user and authorization of a process flow or information transaction, an authorizer has to visit specific predefined site/URL to seek authorization pending information, and have to establish his/her identity so that the notifications intimating the arrival of the specific information for the registered client.

Push technology (server push) is a type of communication where a request for given information flow or information transaction is initiated by a “publisher” or server. Efforts have been made in the prior art to use the push technology for establishing the services and sending push notifications.

For example, U.S. Pat. No. 8,099,764 B2 describes a system and method of authentication and authorization between a client, a server and a gateway to facilitate communicating a message between the client and the server through the gateway. The client has a trusted relationship with each of the gateway and the server. A method includes registering the client with the gateway. The client also constructs the address space identifying the gateway and the client. The client communicates the address space to the server. The client receives an identity identifying the server. If the client authorizes to receive a message from the server through the gateway, the client informs the authorization to the gateway. The client puts the identity identifying the server on a list of servers which are authorized to send messages to the client.

Further, Canadian Patent No. CA2369476 A1 describes a system and method for internet bill presentment and payment using a “push” model to intelligently “push” bills from the billing entities to the customers without the active enrollment by the customer. Initially, a bill servicing entity data mines payments made by the customers to that billing entity. The data mining reveals the financial institution that a customer uses to pay his bills and the customer's account number at that customer's financial institution. After determining the particular financial institutions used by the customers, the bill servicing entity is able to send electronic bill packets to the customers respective financial institutions. By enlisting a plurality of financial institutions used by a plurality of billing entities, most of the customers' bills can be presented to the customers at the customers' financial institution with no effort by the customer. After presentment of the bills to the customers, the system will accept payment and provide for settlement of the payment.

### FEATURES OF THE RELATED ART

The related art establishes various methods of authorization where the entity/person who is supposed to authorize the process flow requests for the access to the process.

The authorization process is completely dependent on the entity/person seeking the authorization.

User does not get intimation of the pending authorization process resulting in time, money and effort losses.

In case, the user receives the intimation in form of email, SMS or other digital messaging format, the user cannot act on the message, to complete authorization process the user needs to visit the particular system/URL.

No unified authorization process allowing user to give information and allowing the user to act process the information flow.

Accordingly, there exists a need to provide a system and a method for push authorization which overcomes the some of the above mentioned features of the related art.

### Aspects of the Invention

An aspect of some embodiments in accordance with the present disclosure is to provide a seamless authorization mechanism allowing users to receive authorization requests specific to a user or a group of users.

Another aspect is to store the authorization request till the time being it is not presented to the intended receiver.

Yet another aspect is to present the authorization request to the intended user over any of the available registered digital interaction channel/front end when a user is available.

Still another aspect is to allow user to authorize/process the authorization request.

### SUMMARY

Accordingly, the present disclosure provides a system for push authorization of an information transaction providing seamless authorization mechanism allowing users to receive authorization requests. The system includes a push request generator (PRG) connected to multiple applications/systems. The push request generator (PRG) is capable of generating a push authorization request (PAR) at one end and is connected to a Push authorization Node (PAN) at other end. The push request generator (PRG) stores and maintains the push authorization request till a respective client/user process the request, wherein the push request generator (PRG) stores authorizing elements data pertaining to specific user and validate the push authorization request (PAR) with the authorization elements input sent from the client for specific PAR.

Further, the system includes the push authorization node (PAN). The push authorization node (PAN) is capable of receiving and routing a push authorization request to the intended user. The push authorization node (PAN) is connected to the push request generator (PRG) for serving the generated requests back and forth, maintaining their status, managing and routing their delivery to the internal clients connected to the system or to the external clients by communicating with the external Push Authorizing systems PAN.

Furthermore, the system includes a plurality of client devices. Each client device of the plurality of client devices includes an input device, an output device, a memory, a processor, a security module, an encryption module, a communication module and a plurality of applications. The communication module of the client device communicates with the push authorization node (PAN). The memory of the client may securely store the Authorization elements data for specific users for validation against input from the user pertaining to specific PAR. Wherein the push authorization node (PAN) regulates and diverts the push authorization requests (PAR) to the user depending upon load, type and communication channel.

### BRIEF DESCRIPTION OF THE DRAWINGS

FIG. 1 is a schematic drawing of a push authorization system, in accordance with the present disclosure;

FIG. 2 is schematic drawing showing a device/client interface with the push authorization system of FIG. 1;

FIG. 3 is schematic drawing showing communication flow in the push authorization system of FIG. 1;

FIG. 4 shows push authorization system of FIG. 1 with multiple push authorization nodes (PAN);

FIG. 5 shows a push authorization network;

FIG. 6 shows a push authorization system with the authorization element data storage at client; and

FIG. 7 shows a push authorization system with the authorization element data stored at push request generator.

### DETAILED DESCRIPTION

The foregoing aspects of the disclosure are accomplished and some undesired features associated with the related art techniques and approaches are overcome by embodiments in accordance with the present disclosure as described below.

The present disclosure provides a push authorization system that gives a seamless authorization mechanism allowing users to send and receive authorization requests, specific to the user or a group of users. The present disclosure also provides a method that allows the authorizing user to be in complete control of the authorization process/function/system but at the same time increases the user's as well as systems efficiency and reliability.

The present disclosure is illustrated with reference to the accompanying drawings, throughout which reference numbers indicate corresponding parts in the various figures. These reference numbers are shown in bracket in the following description.

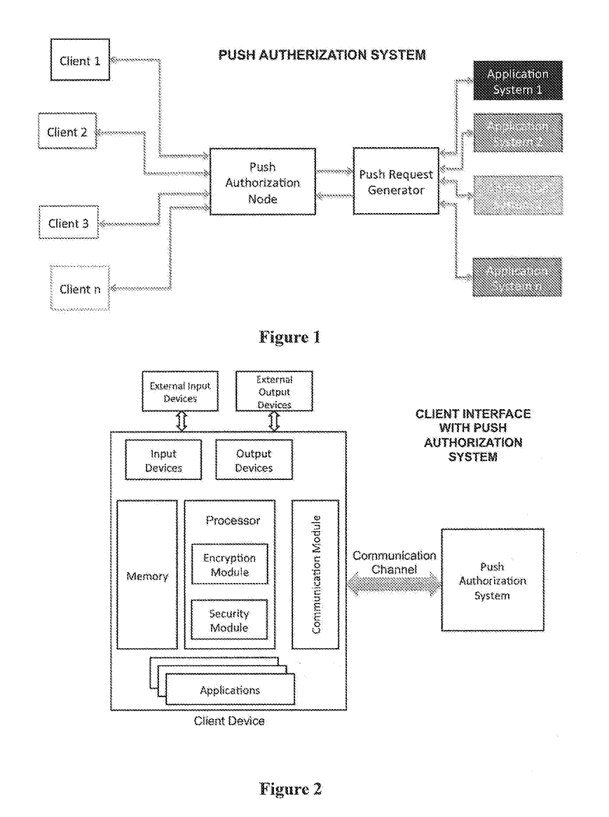

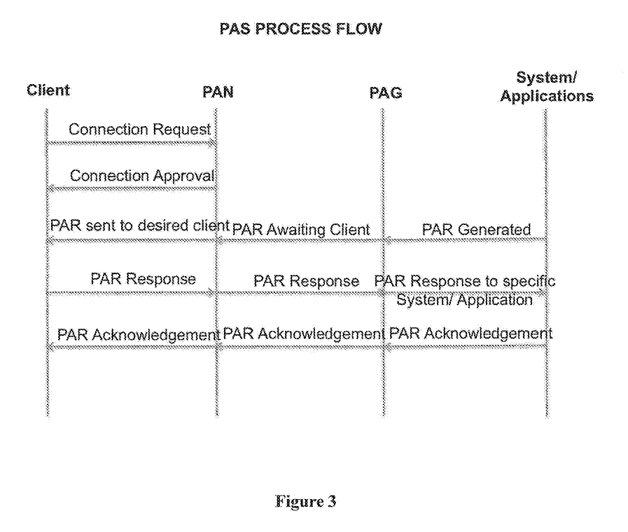

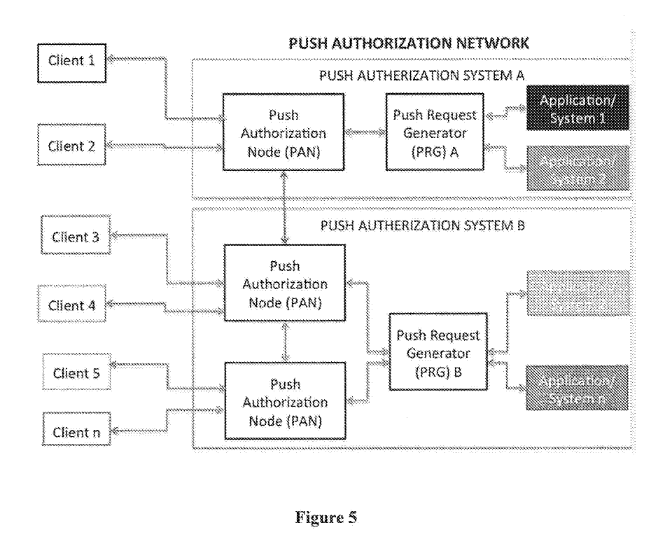

Referring to FIGS. 1-7, a system for push authorization of an information transaction providing seamless authorization mechanism allowing users to receive authorization requests, in accordance with the present invention is shown. The system comprises a push request generator (PRG), at least one push authorization node (PAN), and a plurality of client devices and applications/systems generating valid Push Authorization Request. For the purpose of brevity, only one system is described. However, it may be evident to those skilled in the art that such multiple systems are capable of generating and authorizing the Push Authorizing Requests (PAR) generated by themselves of by other systems as shown in FIG. 5.

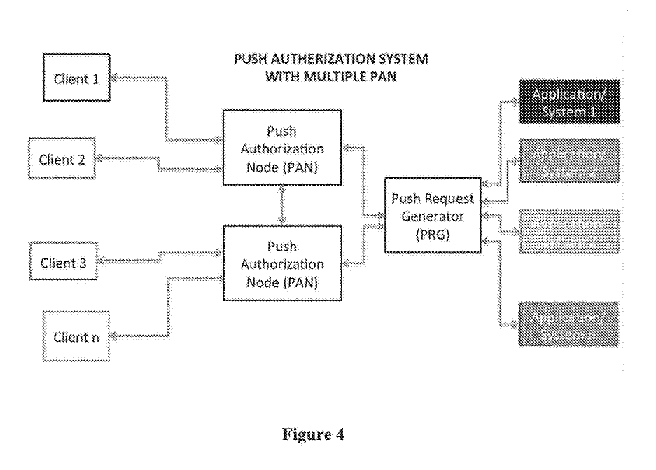

The Push Request Generator (PRG) along with application/system seeking the authorization forms first element of the system which connects to multiple source application through which a Push Authorization Request (PAR) is generated. The PRG maintains the list of authorized PAR generators, the PAR generated, status of the PAR generated, along with the at least one Push Authorization Node (PAN) that it connects too. In an embodiment, the push request generator is connected to multiple push authorizing nodes as shown in FIG. 4. The at least one push authorization node (PAN) is capable of receiving and routing a push authorization request from the user to intended authorizing recipient. The push authorization node (PAN) regulates and diverts the push authorization requests (PAR) to the user depending upon load, type, and communication channel. The push authorization node (PAN) verifies client/device and grants authorization for further communication.

The push authorization node (PAN) connects to the push requests generator (PRG). The Push Authorization Node (PAN) serves the generated requests back and forth within one system or to other external system or multiple systems, maintaining their status, validity and other relevant criteria's. The generated push authorization requests (PAR) pending for authorization are stored within the Push Authorization Node till the respective client/user is available. The push requests generator (PRG) is connected to various applications/systems. In an embodiment, the application may be a native application or a third party application.

The main function of the push requests generators (PRG) is to receive, maintain push authorization requests (PAR) and facilitate authorization process.

The push authorization node (PAN) allows various user/client devices to be connected thereto. Also push authorization node (PAN) connects to other external Push Authorization Nodes (PAN) external to the systems routing the PAR to specific clients connected to external systems and communicating with them.

Each client device of the plurality of client devices includes an input device, an output device, a memory, a processor, a communication module and a plurality of applications running thereon. The processor includes an encryption module and a security module. Specifically, the communication module of the client device communicates with the push authorization node (PAN). The PAN allows various user/client devices to be connected thereto through a communication channel. The communication may be encrypted and secured. In an embodiment, the client device includes anyone but limited to a mobile communication device, a computer and the like.

Specifically, the user authorizes the authorization request sent by the push authorization node (PAN) by providing any one of unique authorization element like password, personal identification number (PIN), specific color pattern, graphical pattern, sequential graphic identification, fingerprint, retina scan, voice pattern recognition, facial feature recognition, digital fingerprint, digital certificate, digital token and combination thereof. However, it is understood that the target user may reject/refuse the authorization and the method of authorization is possible without the use of authorization parameters in other alternative embodiments of the present invention.

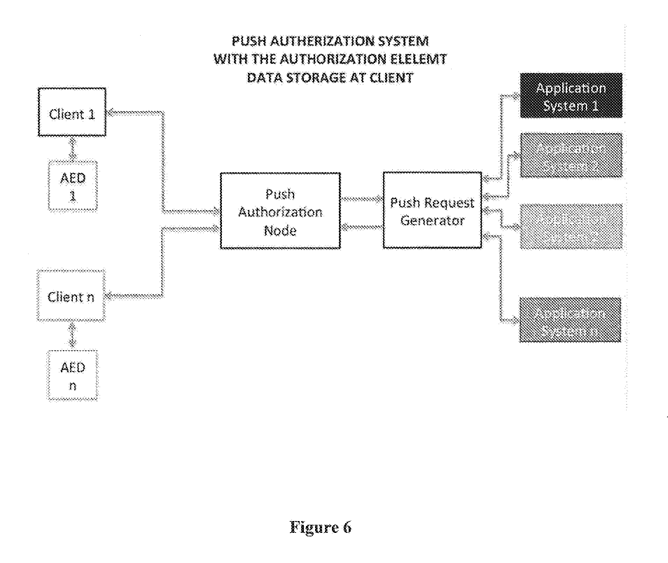

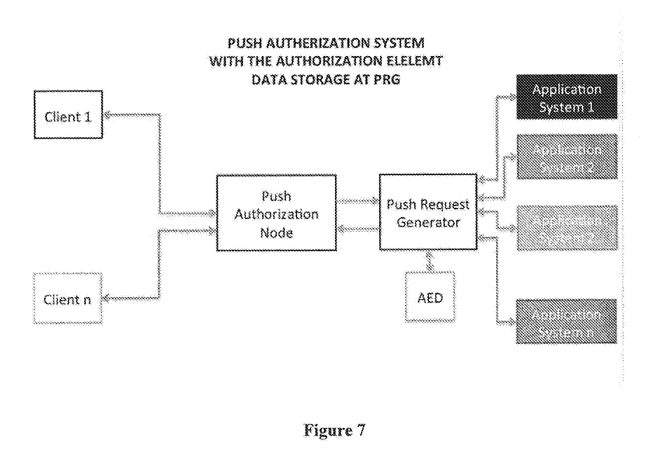

Each client device or PRG or both stores the authorization elements against each user as shown in FIGS. 6 and 7. For a specific push authorization request (PAR) that user wishes to authorize, the authorization element is presented by user on the client for verification.

The system/application creating the push authorization request (PAR) or Authorizing user can define the specific type of authorization element by which authorizing user can authorize the valid PAR.

If Authorization Element Data (AED) is stored on the client/device the verification of the element is done at the client end. The status as authorized or rejected for the specific PAR is appended to PAR. The appended PAR is secured for the communication and sent back to originating PRG through the network of PAN.

At the originating PRG, after receipt of the specific PAR its status is updated and made available to respective application/(s).

In case of the Authorization Element Data (AED) for verification is stored at originating PRG for the specific user/client the authorization element data is appended to the respective PAR by the client. This appended PAR is secured and sent back to originating PRG. At originating PRG the appended PAR is verified against the stored authorization element. The success or failure status for the specific PAR is updated in the PRG and communicated back to the client and is made available the request generator/application for further processing.

In one embodiment, the push authorization node (PAN) receives the push authorization request only from a preregistered authorization seeker.

In another aspect, the present disclosure provides a method for push authorization of an information transaction providing seamless authorization mechanism allowing users to receive authorization requests. The method includes sending an authorization request by a client/user device to a push request generator (PRG). In one embodiment, the push request generator (PRG) receives the push authorization request (PAR) only from a preregistered authorization seeker.

The push request generator (PRG) acknowledges the authorization request sent by the client device verifies the client device and grants authorization to the client device for further communication, wherein the push request generator (PRG) is connected to a Push authorization Node (PAN) at other end. Thereafter, the method includes serving the generated requests by the push authorization node (PAN) back and forth, maintaining their status, validity and other relevant criteria.

Thereafter, the method includes serving the generated requests by the push authorization node (PAN) by connecting to the push authorization nodes external to the push authorization request generating system.

Finally, the method includes authorizing/granting by the user the authorization request sent by the push authorization node (PAN) using a predefined parameter.

The predefined parameters for authorizing the push authorization request by the user is selected from authorization elements like unique password, personal identification number (PIN), specific color pattern, graphical pattern, sequential graphic identification, fingerprint, retina scan, voice pattern recognition, facial feature recognition, digital fingerprint, digital certificate, digital token and combination thereof. However, it is understood that the target user may reject/refuse the authorization and the method of authorization is possible without the use of authorization parameters in other alternative embodiments of the present invention.

The method further comprises storing authorizing elements at any of the client/device and at the push requests generator (PRO). The method then involves communicating, routing and diverting the push authorization request (PAR) between independent Push Authorization systems by the push authorization node (PAN). Thereafter, the method involves determining the authorization element for a specific push authorization request (PAR) or a set of push authorization requests (PAR) by the user or an application/system.

Specifically, the push authorization node (PAN) receives the push authorization request only from a preregistered authorization seeker.

Once the user device is registered with the push authorization node (PAN), the user is able to receive push authorization requests (PAR) over any of the devices that are connected to the system at that point of time.

The system allows various applications like native application or third party application or external system to send authorization requests to the system registered users over various technologies, networks and the communication channels.

In an embodiment, the user as well as authorization seeker is able to decide the level of authorization and to select and enforce the authorization method to be adopted thereof. Authorization seeker can define the specific authorization element by which the push authorization request (PAR) can be defined while creating push authorization request (PAR) through the push request generator (PRG). Whereas authorizing user can specify while registering client with specific push authorization node (PAN) which authorization elements it can support.

### Advantages of Some Embodiments of the Disclosure

1. The system and the method ensure identification, authentication and authorization of a user in information based transaction.

2. The system and the method allow users to be in complete control of the authorization process/function/system and at the same time increase efficiency and reliability exponentially.

3. The system and the method allow a speedy and efficient authorization reducing time and effort for authorization and authentication.

The foregoing features of the disclosure are accomplished and some undesired features associated with related art techniques and approaches are overcome by the present disclosure described in the present embodiment. Detailed descriptions of the preferred embodiment are provided herein; however, it is to be understood that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or matter. The embodiments of the invention as described above and the methods disclosed herein will suggest further modification and alterations to those skilled in the art. Such further modifications and alterations may be made without departing from the spirit and scope of the invention.

1. A system for push authorization of an information transaction providing seamless authorization mechanism allowing users to receive authorization requests, the system comprising:
a push request generator (PRG) connected to multiple applications/systems, the push request generator (PRG) capable of generating a push authorization request (PAR) at one end and connected to a Push authorization Node (PAN) at other end, the push request generator (PRG) stores and maintains the push authorization request (PAR) till a respective client/user processes the request, wherein the push request generator (PRG) stores authorizing elements data pertaining to specific user and validates the push authorization request (PAR) with the authorization elements input sent from the client for specific push authorization request (PAR);
the push authorization node (PAN) capable of receiving and routing the push authorization request (PAR) from the user, the push authorization node (PAN) connected to the push request generator (PRG) for serving the generated requests back and forth, maintaining their status, managing and routing their delivery to the internal clients connected to the system or to the external clients by communicating with the external Push Authorizing systems PAN's; and
a plurality of client devices, each client device of the plurality of client devices having an input device, an output device, a memory, a processor, a security module, an encryption module, a communication module and a plurality of applications, wherein the communication module of the client device communicates with the push authorization node (PAN) and the memory securely stores the Authorization elements data for specific users for validation against input from the user pertaining to specific PAR,
wherein, the push authorization node (PAN) regulates and diverts the push authorization requests (PAR) to the user depending upon load, type, and communication channel.

2. The system as claimed in claim 1, the user grants the authorization to the authorization request sent by the push authorization node (PAN) by providing authorization element like one of unique password, personal identification number (PIN), specific color pattern, graphical pattern, sequential graphic identification, fingerprint, retina scan, voice pattern recognition, facial feature recognition, digital fingerprint, digital certificate, digital token and combination thereof.

3. The system as claimed in claim 1, wherein the push request generator (PRG) receives the push authorization request (PAR) only from a preregistered authorization seeker.

4. The system as claimed in claim 1, wherein the client devices includes any one of a mobile, a computer and other communication device.

5. A method for push authorization of an information transaction providing seamless authorization mechanism allowing users to receive authorization requests, the method comprising:
sending an authorization request by a user device to a push requests generator (PRG);
acknowledging the authorization request by the push requests generator (PRG);
verifying the client/device by the push authorization node (PAN);
granting authorization by the push authorization node (PAN) to the client device for further communication;
serving the generated requests back and forth, maintaining their status, validity and other relevant criteria’ by a push authorization node (PAN), wherein the push request generator stores the push authorization request till the respective client/user is available; and
granting by the user the authorization request sent by the push authorization node (PAN) using a predefined parameter.

6. The method as claimed in claim 5, further comprising:
storing authorizing elements at any of the client/device and at the push requests generator (PRG);
communicating, routing and diverting the push authorization request (PAR) between independent Push Authorization systems by the push authorization node (PAN); and
determining the authorization element for a specific push authorization request (PAR) or a set of push authorization requests (PAR) by the user or an application/system.

7. The method as claimed in claim 5, wherein the predefined parameters for granting the authorization request by the user includes any one of unique password, personal identification number (PIN), specific color pattern, graphical pattern, sequential graphic identification, fingerprint, retina scan, voice pattern recognition, facial feature recognition, digital fingerprint, digital certificate, digital token and combination thereof.

8. The method as claimed in claim 5, wherein the push request generator (PRG) receives the push authorization request (PAR) only from a preregistered authorization seeker.

9. The method as claimed in claim 5, wherein the client devices includes any one of a mobile, a computer and other communication device.
